(19) United States
(12) Patent Application Publication
(10) Pub. No.: US 2012/0306263 A1
(43) Pub. Date: Dec. 6, 2012

(54) Control Device for Electrically Powered Vehicle

(75) Inventors: Naoyuki TASHIRO, Atsugi-shi (JP); Shinya SATO, Hitachinaka-shi (JP); Hitoshi KOBAYASHI, Tokyo (JP)

(73) Assignee: Hitachi Automotive Systems, Ltd., Hitachinaka-shi (JP)

(21) Appl. No.: 13/482,056

(22) Filed: May 29, 2012

(30) Foreign Application Priority Data
May 30, 2011 (JP) 2011-120379

(51) Int. Cl. B60L 1/00

(52) U.S. Cl. 307/9.1

(57) ABSTRACT

A control device for an electrically powered vehicle, mounted to the electrically powered vehicle, includes: a current control element that takes off a charging current to be supplied to a low voltage battery in order to charge up the low voltage battery from an output current on the low voltage battery side of a voltage conversion device that performs voltage conversion between voltage of a high voltage battery and voltage of the low voltage battery; and an integrated control unit that determines a charging current value for the charging current based upon accumulated power information related to power accumulated in the low voltage battery and conversion efficiency of the voltage conversion by the voltage conversion device, and that controls the current control element so as to take off the charging current specified by the charging current value with the current control element.

### INCORPORATION BY REFERENCE

The disclosure of the following priority application is herein incorporated by reference: Japanese Patent Application No. 2011-120379 filed May 30, 2011.

### BACKGROUND OF THE INVENTION

1. Field of the Invention

The present invention relates to a control device for an electrically powered vehicle.

2. Description of Related Art

In recent years attention has been directed to electric vehicles, since they impose a relatively small burden upon the environment. Generally, a drive system for an electric automobile utilizes a high voltage battery as a source of electrical power, for example a lithium ion battery or the like of voltage 300 V or more, and controls a high output motor for driving the wheels using an inverter. On the other hand there are various auxiliary electrical devices (auxiliary equipment) other than the motor drive system that are needed for traveling, such as power steering, headlights, a radiator fan, audio devices, a navigation system, and so on. In order to operate these auxiliary devices (auxiliary equipment), the electric automobile is equipped with a low voltage battery (a 12 V lead-acid battery or the like) that is separate from the high voltage battery, and power is supplied from this low voltage battery. With an electric automobile, the method is generally adopted of charging up the low voltage battery by connecting the high voltage battery and the low voltage battery together via a DC-DC converter, and of reducing the voltage of the high battery with this DC-DC converter.

It is desirable to operate the DC-DC converter at high efficiency in order to reduce the power consumption of the electric automobile and to increase its range. In Japanese Laid-Open Patent Publication 2010-136495, a technique of operating the DC-DC converter intermittently is disclosed, in which the operation of the DC-DC converter is stopped if the voltage of the low voltage battery has dropped to a lower limit threshold voltage or if that voltage has risen to an upper limit threshold voltage, while the DC-DC converter is operated in other circumstances.

### SUMMARY OF THE INVENTION

With this technique described in Japanese Laid-Open Publication 2010-136495, there is the problem that the DC-DC converter cannot necessarily be driven at high efficiency, since this technique only extends as far as suppressing the period in which the DC-DC converter is intermittently operated at low load, in which its efficiency is poor.

According to the 1st aspect of the present invention, a control device for an electrically powered vehicle, mounted to the electrically powered vehicle, comprises: a current control element that takes off a charging current to be supplied to a low voltage battery that supplies power to auxiliary equipment mounted to the electrically powered vehicle in order to charge up the low voltage battery from an output current on the low voltage battery side of a voltage conversion device that performs voltage conversion between voltage of a high voltage battery that, along with supplying power to a motor that propels the electrically powered vehicle and power to the auxiliary equipment, charges up the low voltage battery and voltage of the low voltage battery; and an integrated control unit that determines a charging current value for the charging current based upon accumulated power information related to power accumulated in the low voltage battery and conversion efficiency of the voltage conversion by the voltage conversion device, and that controls the current control element so as to take off the charging current specified by the charging current value with the current control element.

According to the 2nd aspect of the present invention, in the control device for the electrically powered vehicle according to the 1st aspect, it is preferred that, when an output current value of the output current is larger than a index current value that specifies current outputted from the low voltage battery side of the voltage conversion device when the conversion efficiency is at a highest value, the integrated control unit pulls down the output current value by controlling the current control element, so as to make difference between the output current value and the index current value small.

According to the 3rd aspect of the present invention, in the control device for the electrically powered vehicle according to the 2nd aspect, it is preferred that, when the output current value is higher than the index current value, and the voltage of the low voltage battery is lower than a first threshold value, the integrated control unit stops control of the current control element for lowering the output current value.

According to the 4th aspect of the present invention, in the control device for the electrically powered vehicle according to the 1st aspect, it is preferred that the current control element further takes off the charging current based upon the output current and supplied current supplied, from the output current, to the auxiliary equipment; and the integrated control unit further controls output of the auxiliary equipment and, when an output current value of the output current is smaller than an index current value that specifies current outputted from the low voltage side of the voltage conversion device when the conversion efficiency is at a highest value, the integrated control unit pulls up the output current value by controlling the output of the auxiliary equipment, so as to make difference between the output current value and the index current value small.

According to the 5th aspect of the present invention, in the control device for the electrically powered vehicle according to the 4th aspect, it is preferred that the auxiliary equipment includes first auxiliary equipment and second auxiliary equipment whose time constant is longer than time constant of the first auxiliary equipment; the first auxiliary equipment is electrically connected to the low voltage battery, not via the current control element; the second auxiliary equipment, along with being electrically connected to the low voltage battery via the current control element, is also electrically connected to the high voltage battery via the voltage conversion device; and when the output current value is smaller than the index current value, the integrated control unit pulls up the output current value by controlling output of the second auxiliary equipment, so as to make the difference small.

According to the 6th aspect of the present invention, in the control device for the electrically powered vehicle according to the 5th aspect, it is preferred that the first auxiliary equipment includes at least one of an electronic control device, a braking device, a power steering device, an illumination device, and a direction display device.

According to the 7th aspect of the present invention, in the control device for the electrically powered vehicle according to the 1st aspect, it is preferred that the integrated control unit further controls the voltage conversion device, and, when the voltage of the low voltage battery is greater than a second threshold value, the integrated control unit makes the output current value approximately zero by controlling the voltage conversion device; and the auxiliary equipment is supplied with power by the low voltage battery.

According to the 8th aspect of the present invention, in the control device for the electrically powered vehicle according to the 1st aspect, it is preferred that the current control element includes any electric circuit element of an electric circuit element that either takes off or does not take off the charging current according to control by the integrated control unit and an electric circuit element that is capable of continuously changing the charging current value of the charging current that is taken off according to the control by the integrated control unit.

According to the 9th aspect of the present invention, in the control device for the electrically powered vehicle according to the 1st aspect, it is preferred that the control device for the electrically powered vehicle further comprises a current value detection device that measures output current value of the output current. Either: the current value detection device is disposed between the voltage conversion device and the current control element that are mutually electrically connected together, and between the voltage conversion device and the auxiliary equipment that are mutually electrically connected together, and is electrically connected to the voltage conversion device, to the current control element, and to the auxiliary equipment; or the current value detection device is included in the voltage conversion device, and is electrically connected to the current control element and to the auxiliary equipment.

### BRIEF DESCRIPTION OF THE DRAWINGS

FIG. 1 is a figure showing the system structure of an electrically powered vehicle;

FIG. 2 is a figure showing the structure of a control device for an electrically powered vehicle according to a first embodiment of the present invention, and also showing the structure of a power supply system for auxiliary equipment of that vehicle;

FIG. 3 is a figure showing the details of a current control element;

FIG. 4 is a figure showing the details of an alternative current control element;

FIG. 5 is a figure showing the relationship between the conversion efficiency of a DC-DC converter and its output current;

FIGS. 6A through 6D are figures showing the details of control performed by this control device for an electrically powered vehicle according to the first embodiment of the present invention;

FIG. 7 is a flow chart showing a control procedure performed by an integrated controller;

FIG. 8 is a figure showing the structure of a control device for an electrically powered vehicle according to a second embodiment of the present invention, and also showing the structure of a power supply system for auxiliary equipment of that vehicle;

FIGS. 9A through 9D are figures showing the details of control performed by this control device for an electrically powered vehicle according to the second embodiment of the present invention;

FIGS. 10A and 10B are figures showing an example of auxiliary equipment output control;

FIGS. 11A and 11B are figures showing another example of auxiliary equipment output control;

FIG. 12 is a flow chart showing a control procedure performed by an integrated controller of this embodiment;

FIG. 13 is a figure showing the structure of a control device for an electrically powered vehicle according to a third embodiment of the present invention, and also showing the structure of a power supply system for auxiliary equipment of that vehicle; and

FIG. 14 is a figure showing the relationship between the conversion efficiency and the output current of a DC-DC converter of a variant embodiment of the present invention.

### DESCRIPTION OF THE PREFERRED EMBODIMENTS

### First Embodiment

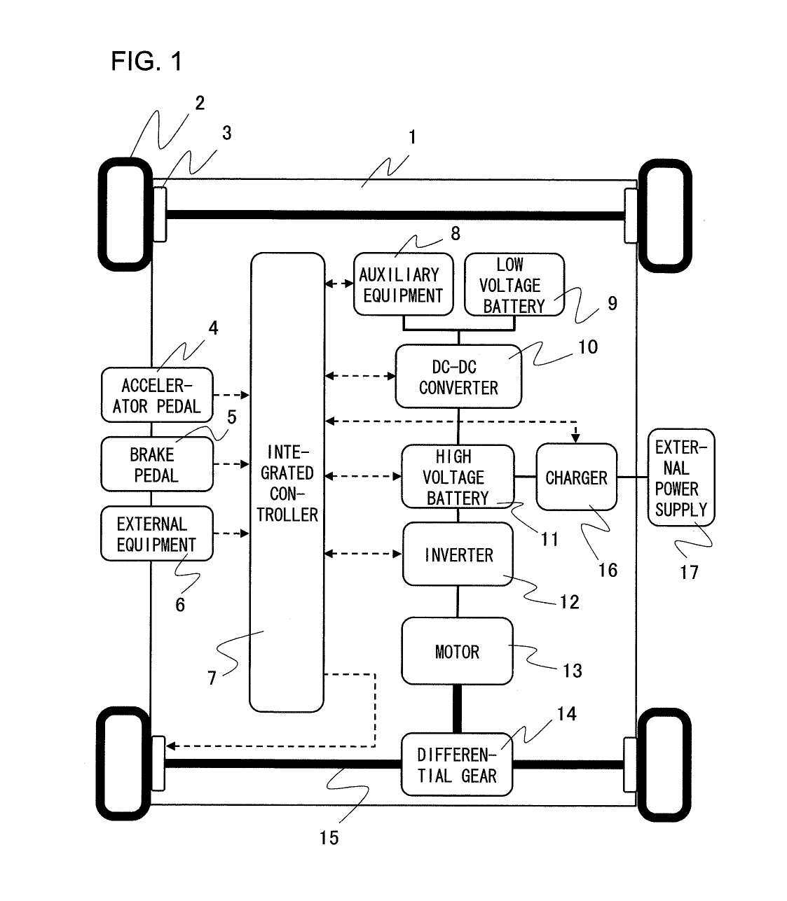

A control device 50 for an electrically powered vehicle according to a first embodiment of the present invention will now be explained with reference to FIGS. 1 through 7. FIG. 1 shows the system structure of an electrically powered vehicle to which is mounted this control device 50 for an electrically powered vehicle according to the first embodiment, as well as the structures of control devices of other embodiments and variant embodiments to be described hereinafter. This electrically powered vehicle is, for example, a hybrid automobile or an electric automobile or the like. As drive train components, a motor 13, a differential gear 14, drive shafts 15, a brake (i.e. a braking device) 3, and tires 2 are mounted to the body 1 of this electrically powered vehicle. Moreover, as components that are necessary for vehicle operation, high voltage electrical system components that are required for driving the motor 13 and also low voltage electrical system components that are related to operating stability and comfort are provided. Representative high voltage electrical system components are an external power supply 17, a charger 16, a high voltage battery 11, an inverter 12, and so on. And representative low voltage electrical system components are a DC-DC converter 10 (i.e. a voltage conversion device), a low voltage battery 9, and auxiliary equipment 8, an integrated controller (or integrated control device) 7 that serves as for example an ECU (engine control unit) and so on. It should be understood that information such as accelerator pedal information from an accelerator pedal 4, brake pedal information from a brake pedal 5, and external information from external equipment 6 such as a navigation system and so on is inputted to this integrated controller 7. The auxiliary equipment 8 may include, for example, a cooling device, an air conditioning device, illumination devices such as headlights (front lights) and so on, and a power steering system (a steering assistance device).

Next, the operation of these devices will be explained. On the basis of the accelerator pedal information from the accelerator pedal 4, the brake pedal information from the brake pedal 3, and the external information from the external equipment 6, the integrated controller 7 calculates the drive force and braking force that are being requested for the electrically powered vehicle, and transmits a drive force command and a braking force command to the inverter 12 and to the brake 3 respectively. On the basis of this drive force command from the integrated controller 7, the inverter 12 performs drive control of the motor 13 by calculating the motor drive current that is required for driving the electrically powered vehicle and by receiving supply of power from the high voltage battery 11 corresponding to the result of this calculation of the motor drive current. In a similar manner, on the basis of a braking force command from the integrated controller 7, the brake 3 also operates a brake caliper (not shown in the figures) by calculating the amount of brake pressure that is required for braking the electrically powered vehicle. It should be understood that when, according to the operational region, coordinated regenerative braking control is to be performed in order to enhance the energy efficiency, the integrated controller 7 performs calculation to allocate the target braking force between brake braking force and regenerative braking force by the motor 13, and transmits the results of this calculation of braking forces to the brake 3 and to the inverter 12 respectively. The regenerated power obtained from the motor 13 at this time is accumulated in the high voltage battery 11 via the inverter 12.

When charging of the high voltage battery 11, after having confirmed the connection of the external power supply 17 and the charger 16, the integrated controller 7 calculates the target charging voltage and the current to be applied for charging, and transmits these to the charger 16. And the charger 16 performs charging of the high voltage battery 11, on the basis of this target voltage value and this target current value command that it has received.

Since the voltage supplied by the high voltage battery 11 is too high to serve as a source of drive power for the auxiliary equipment 8, accordingly reduction of this high voltage is performed by connecting the DC-DC converter 10 to the high voltage battery 11. It should be understood that the low voltage battery 9, that is a lead-acid battery or the like, is connected in parallel with the auxiliary equipment 8, so that the presence of a power buffer is ensured during starting and in emergency.

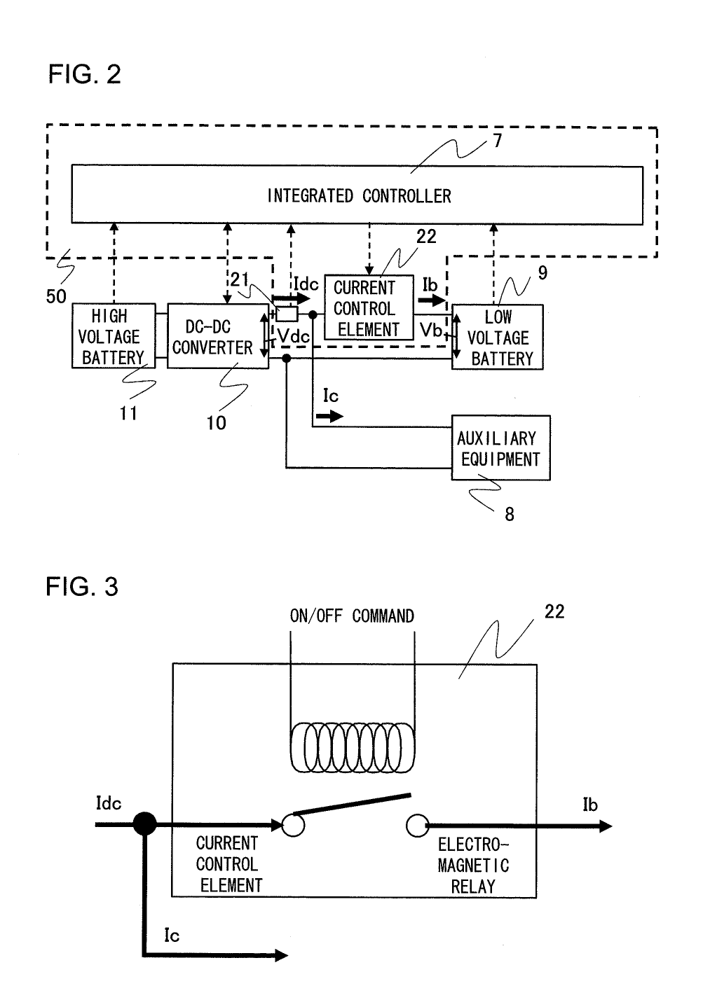

Next, the details of the structure of this control device for an electrically powered vehicle 50 according to the first embodiment, and of the associated structure for supplying power to the auxiliary equipment, will be explained with reference to FIG. 2. This control device for an electrically powered vehicle 50 includes the integrated controller 7, a current sensor 21 and a current control element 22. As explained above, the DC-DC converter 10 is connected to the high voltage battery 11, and, after the voltage of the high voltage battery 11 has been reduced by the DC-DC converter 10, its output power is used as a power supply for charging up the low voltage battery 9 and for supply to the auxiliary equipment 8. Here, a relationship given by the equation “Idc=Ib+Ic” holds between the output current Idc on the low voltage battery 9 side of the DC-DC converter 10, the charging current Ib that is supplied to the low voltage battery 9 for charging up the low voltage battery 9, and the supplied current Ic that is supplied to the auxiliary equipment 8 for providing power to the auxiliary equipment 8. It should be understood that the current sensor 21 (that is a current value detection device) is installed to an output terminal on the low voltage battery 9 side of the DC-DC converter 10, and the integrated controller 7 is always able to monitor the output current Idc by using this current sensor 21. Furthermore a current control element 22 is inserted between the DC-DC converter 10 and the low voltage battery 9, and is an electric circuit element such as an electromagnetic relay or a semiconductor element or the like, so that, under control by the integrated controller 7, it is possible to take off the charging current Ib to the low voltage battery 9 while regulating that current. On the other hand, on the basis of accumulated power information related to the accumulated power that corresponds to the voltage of the high voltage battery 11 and so on, and also on the basis of accumulated power information related to the accumulated power that corresponds to the voltage of the low voltage battery 9 and so on, the integrated controller 7 controls the DC-DC converter 10 by turning it ON and OFF, and also determines the charging current value of the charging current Ib that is taken off from the output current Idc by the current control element 22 by controlling this current control element 22.

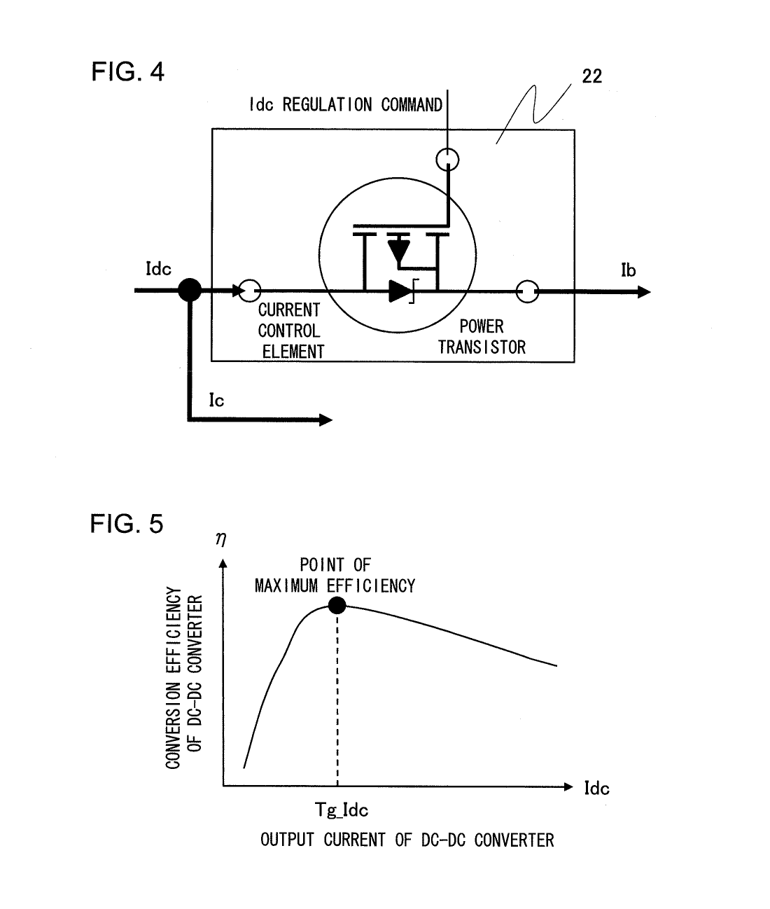

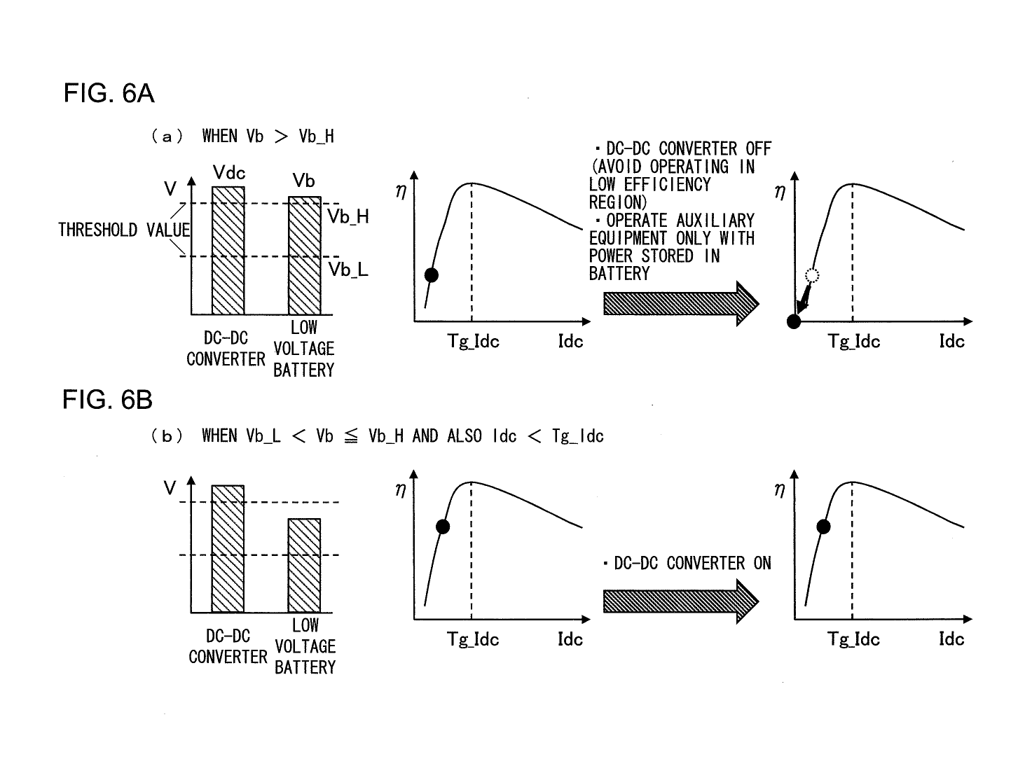

Next, the details of the current control element 22 will be explained with reference to FIGS. 3 and 4. FIG. 3 shows a case in which an electromagnetic relay is employed for the current control element 22, and in this case it is possible to change the output current Idc in an ON/OFF manner according to commands from the integrated controller 7. In other words, according to control by the integrated controller 7, this current control element 22 that includes an electromagnetic relay either takes off a charging current Ib from the output current Idc, or does not take off any such charging current. Moreover, FIG. 4 shows an alternative case in which a power transistor is employed for the current control element 22, and in this case, according to a control signal generated from the integrated controller 7, it is possible to change the charging current value of the charging current Ib that is taken off from the output current Idc in a continuous manner. It should be understood that the current control element 22 is not to be considered as being limited to these two types of device; it would also be possible to employ some other type of device that is capable of controlling a high current.

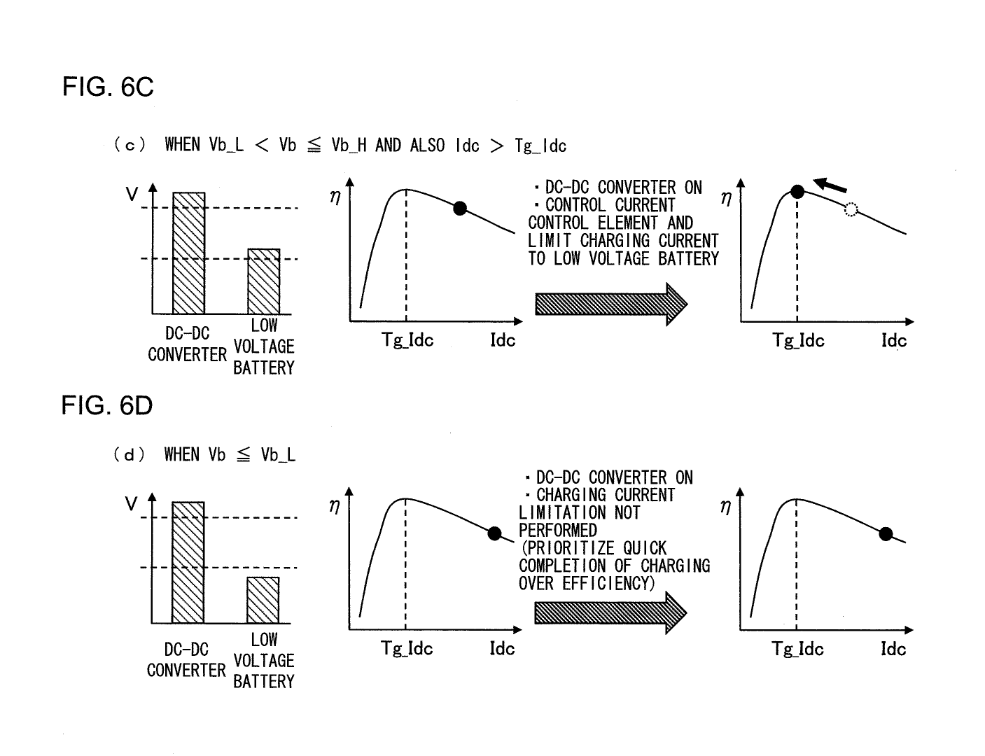

Next, the relationship between the conversion efficiency of the DC-DC converter 10 (i.e. its operating efficiency) and its output current Idc will be explained with reference to FIG. 5. The conversion efficiency of the DC-DC converter 10 depends upon the output current Idc of the DC-DC converter 10, and a index current value is defined as representing the output current value of the output current Idc for which the conversion efficiency attains its highest value. Accordingly, in order to reduce the amount of power consumed by the electric automobile and in order to increase its range, it is desirable for the DC-DC converter 10 to be operated in the vicinity of this index current value for its output current that yields the maximum efficiency.

Thus, in this first embodiment, the following logic is employed in order to implement the concept described above. In concrete terms the index current value Tg_Idc for which the conversion efficiency of the DC-DC converter 10 attains its maximum value, i.e. its target output current, is obtained in advance and is stored in the integrated controller 7. Along with this, the integrated controller 7 always monitors the output current Idc of the DC-DC converter 10 by using the current sensor 21. And, by controlling the current control element 22, the integrated controller 7 regulates the power supplied to the low voltage battery 9 in order to charge it up, so as to bring the value of the output current Idc to be close to this index current value Tg_Idc.

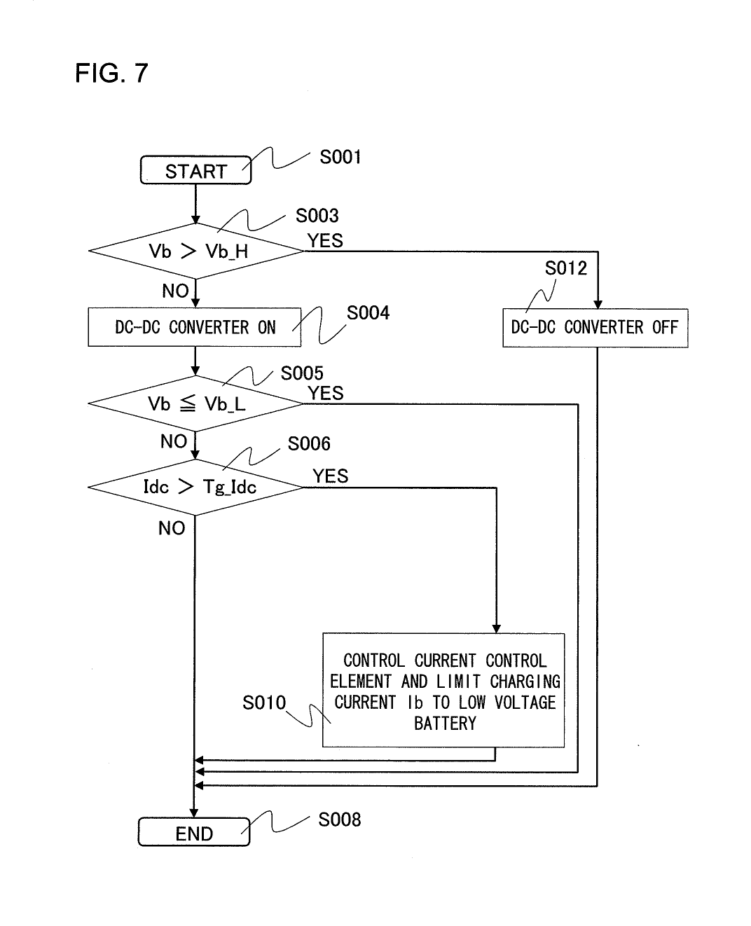

The details of this logic are shown in FIGS. 6A through 6D, using the output voltage Vdc on the low voltage battery 9 side of the DC-DC converter 10, the voltage Vb of the low voltage battery 9, the battery voltage upper limit threshold value for charging control Vb_H, and the battery voltage lower limit threshold value for charging control Vb_L(<Vb_H).

(a) When “Vb>Vb_H”

As shown in FIG. 6A, in the light of the fact that the voltage of the low voltage battery 9 is sufficiently high, the integrated controller 7 turns the DC-DC converter 10 OFF so as to make the value of its output current Idc approximately zero, so that the auxiliary equipment 8 is operated only by the voltage of the low voltage battery 9, in other words only upon the power that has been accumulated in the low voltage battery 9. Due to this, it is possible to avoid operating the DC-DC converter 10 in its low efficiency region.

(b) When “Vb_L<Vb≦Vb_H” and moreover “Idc<Tg_Idc”

As shown in FIG. 6B, although the integrated controller 7 turns the DC-DC converter 10 ON, no control of the current control element 22 is performed.

(c) When “Vb_L<Vb≦Vb_H” and moreover “Idc>Tg_Idc”

As shown in FIG. 6C, the integrated controller 7 turns the DC-DC converter 10 ON. Along with this, the integrated controller 7 controls the current control element 22 so that the output current Idc becomes close to the index current value Tg_Idc, in other words so that the difference between the output current Idc and the index current value Tg_Idc becomes small, and reduces the output current Idc by limiting the charging current Ib to the low voltage battery 9.

(d) When “Vb≦Vb_L”

As shown in FIG. 6D, the integrated controller 7 turns the DC-DC converter 10 ON. Since the voltage of the low voltage battery 9 is lower than the battery voltage lower limit threshold value Vb_L for charging control, and since in this situation quick completion of charging should be prioritized over conversion efficiency, accordingly limitation of the charging current to the low voltage battery 9 by the integrated controller 7 controlling the current control element 22 is not performed.

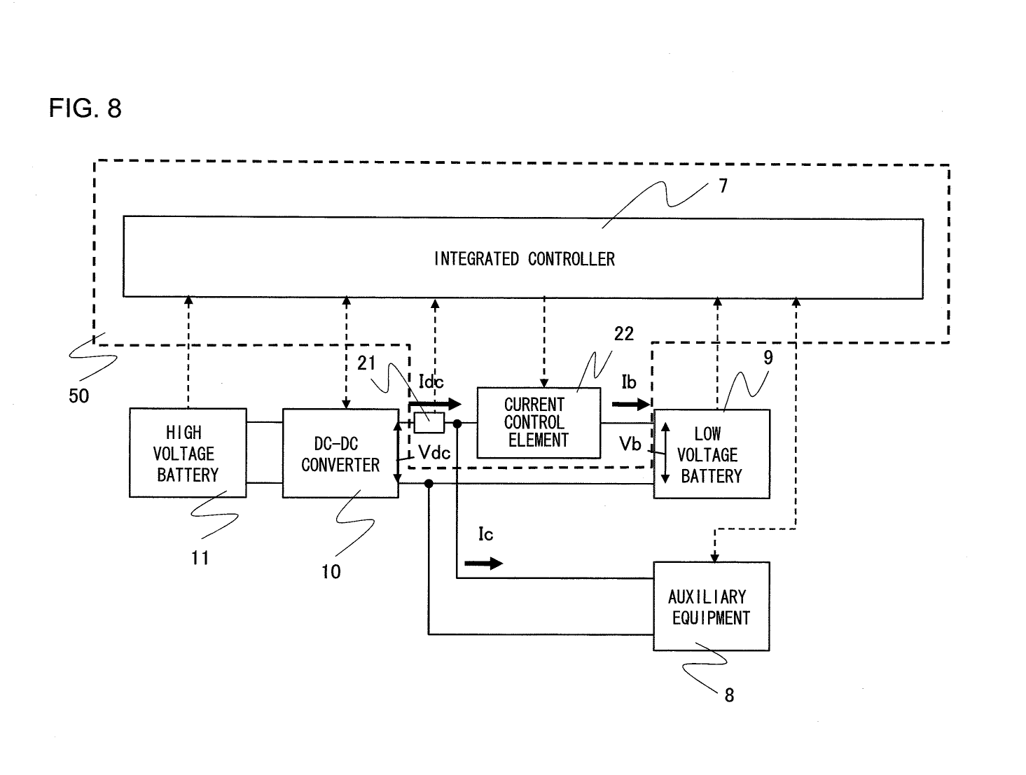

Next, a flow chart of the control procedure performed by the integrated controller 7 in order to perform the control described above is shown in FIG. 7. In a step S001 the control described above is started, and then in a step S003 the integrated controller 7 makes a decision as to whether or not the condition “Vb>Vb_H” is satisfied. In the case of “yes” the flow of control is transferred to a step S012, in which, after the integrated controller 7 turning the DC-DC converter OFF, this processing flow terminates. But in the case of “no”, the flow of control is transferred to a step S004, in which the integrated controller 7 turns the DC-DC converter 10 ON. Then the flow of control proceeds to a step S005, in which the integrated controller 7 makes a decision as to whether or not the condition “Vb≦Vb_L” is satisfied. In the case of “yes” the flow of control terminates, whereas in the case of “no” the flow of control is transferred to a step S006, in which the integrated controller 7 makes a decision as to whether or not the condition “Idc>Tg_Idc” is satisfied. In the case of “yes” the flow of control is transferred to a step S010, in which the integrated controller 7 controls the current control element 22 and limits the charging current Ib to the low voltage battery 9 so as to bring the output current Idc close to the index current value Tg_Idc, and then this processing flow terminates. Moreover, in the case of “no” in the step S006, this processing flow terminates.

The control device for an electrically powered vehicle 50 according to this embodiment is mounted to the body 1 of the electrically powered vehicle. And this control device for an electrically powered vehicle 50 is built to include the current control element 22 and the integrated controller 7. The current control element takes out a charging current Ib to be supplied to the low voltage battery 9 from the output current Idc on the low voltage battery 9 side of the DC-DC converter 10, in order to charge up the low voltage battery 9. The DC-DC converter 10 performs voltage conversion between the voltage of the high voltage battery 11 and the voltage of the low voltage battery 9. The low voltage battery 9 supplies power to auxiliary equipment 8 that is mounted to the body 1 of the electrically powered vehicle. And the high voltage battery 11, along with supplying power to the motor 13 that propels the electrically powered vehicle and to the auxiliary equipment 8, also charges up the low voltage battery 9. Moreover, the integrated controller 7 determines a charging current value for the charging current Ib on the basis of accumulated power information related to the accumulated power, corresponding to the voltage Vb of the low voltage battery 9, and on the basis of the conversion efficiency η of voltage conversion by the DC-DC converter 10. And the integrated controller 7 controls the current control element 22 so that the current control element 22 may take off a charging current Ib having this charging current value. In other words, it becomes possible to operate the DC-DC converter 10 at high efficiency, since the integrated converter 7 performs power regulation related to the supply of power to the low voltage battery 9 while monitoring the output current Idc of the DC-DC converter 10. This provides the beneficial operational effect that it is possible to perform increase of the range of the electrically powered vehicle.

With the control device for an electrically powered vehicle 50 according to this embodiment, if the output current value of the output current Idc is greater than the index current value Tg_Idc of the current outputted from the low voltage battery 9 side of the DC-DC converter 10 when its conversion efficiency η is at its highest value, then the integrated controller 7 reduces the output current value of the output current Idc by controlling the current control element 22, and makes the difference between the output current value of the output current Idc and the index current value Tg_Idc small. Since, due to this, it becomes possible to operate the DC-DC converter 10 at high efficiency, accordingly the beneficial operational effect is obtained that it is possible to perform increase of the range of the electrically powered vehicle.

The control device for an electrically powered vehicle 50 of this embodiment further includes the current sensor 21 that measures the output current value of the output current Idc. This current sensor 21 is disposed between the DC-DC converter 10 and the current control element 22 that are mutually electrically connected together, and moreover between the DC-DC converter 10 and the auxiliary equipment 8 that are mutually connected together, and is electrically connected to the DC-DC converter 10, to the current control element 22, and to the auxiliary equipment 8. Or, the current sensor 21 may be included in the DC-DC converter 10, and may be electrically connected to the current control element 22 and to the auxiliary equipment 8. Due to this, it becomes possible to operate the DC-DC converter 10 at high efficiency while monitoring the output current Idc of the DC-DC converter 10, so that the beneficial operational effect is obtained that it is possible to perform increase of the range of the electrically powered vehicle.

### Second Embodiment

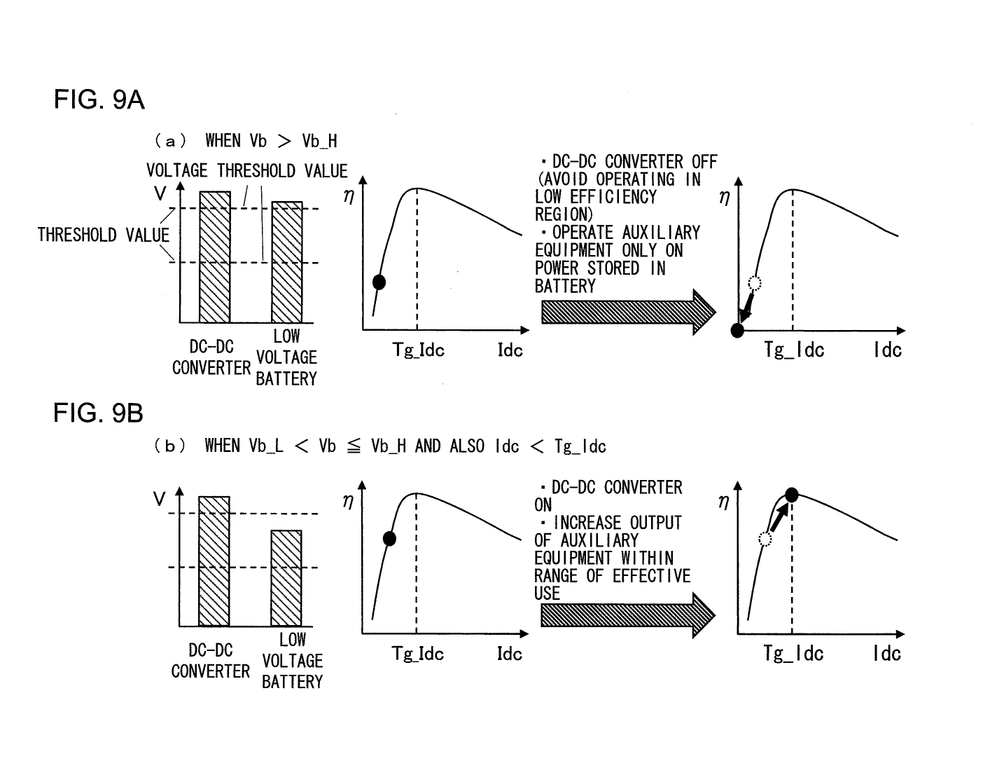

Next, a control device for an electrically powered vehicle 50 according to a second embodiment of the present invention will be explained with reference to FIGS. 8 through 12. FIG. 8 is a structural system diagram showing the structure of this control device 50 for an electrically powered vehicle according to the second embodiment, as well as the power supply for auxiliary equipment associated therewith. This control device for an electrically powered vehicle 50 includes an integrated controller 7, a current sensor 21, and a current control element 22. The way in which regulation by the integrated controller 7 of the output of the auxiliary equipment is performed is different from the case of the first embodiment. It should be understood that, for the regulation of the output of the auxiliary equipment 8, as auxiliary equipment that is particularly suitable for the objective of this embodiment, devices are selected whose time constants during the control are long and for which regulation of the output is comparatively easy, for example a cooling device for some item of equipment or a passenger compartment air conditioning device or the like. Examples of such cooling devices for equipment are devices that maintain the motor 13, the inverter 12, the batteries and so on at suitable temperatures.

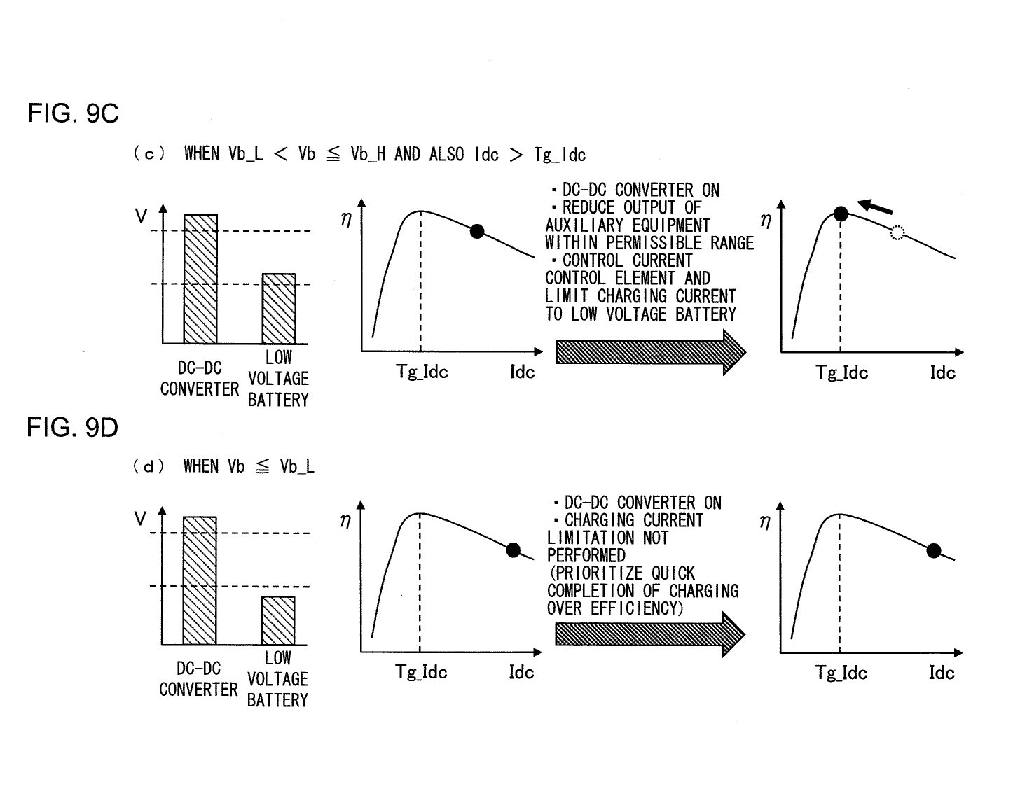

Next, the details of the control performed by the control device for an electrically powered vehicle according to this second embodiment are shown in FIGS. 9A through 9D. The features of difference between this embodiment and the first embodiment are particularly shown in FIGS. 9B and 9C, and the following explanation will concentrate upon these differences.

(b) When “Vb_L<Vb≦Vb_H” and moreover “Idc<Tg_Idc”

As shown in FIG. 9B, an aspect of difference from the first embodiment is that, in this second embodiment, the integrated controller 7 brings the output current Idc close to the index current value Tg_Idc by controlling a part of the auxiliary equipment 8, such as the cooling system or the air conditioning system or the like, so as to increase the output of this part of the auxiliary equipment 8. At this time, the output current Idc comes to be raised, so that the difference between the output current Idc and the index current value

Tg_Idc becomes small.

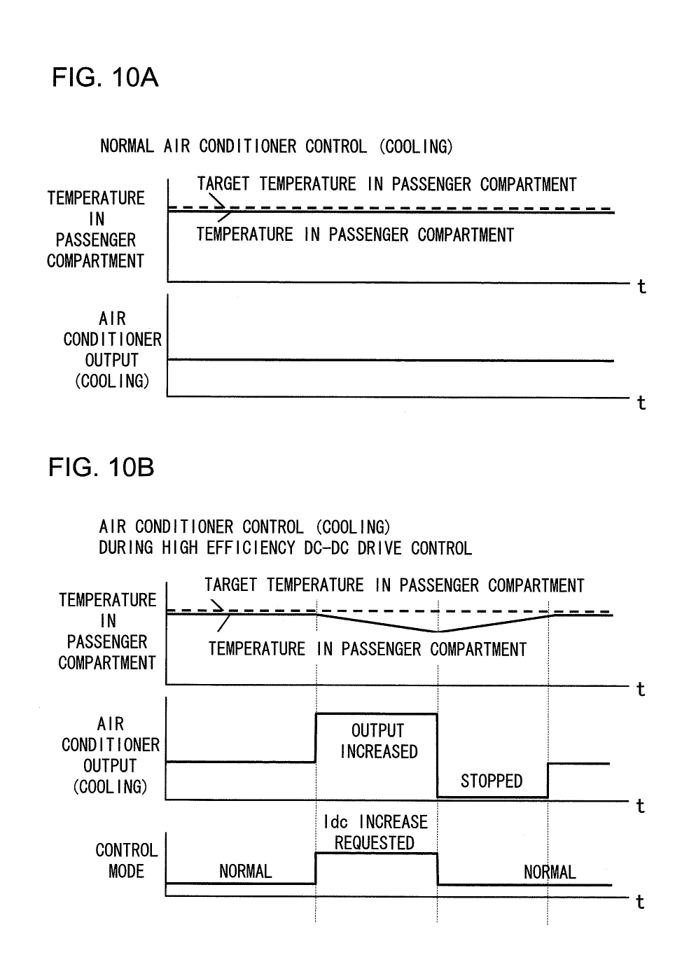

A concrete example of increase of the output of a portion of the auxiliary equipment will now be explained with reference to FIGS. 10A and 10B, while taking an air conditioning device such as an air conditioner or the like (not shown in the figures) as an example of auxiliary equipment. FIG. 10B shows an example of the change over time of air conditioner control (for cooling), and, for comparison, normal control of the air conditioner is shown in FIG. 10A. In normal control, the output of the air conditioner is regulated so that the target temperature in the passenger compartment and the actual temperature in the passenger compartment agree with one another, and, when they agree, the air conditioner output is held almost constant as the time t elapses.

On the other hand, in this embodiment, during an interval in which an auxiliary equipment output increase command is being generated by the integrated controller 7, the air conditioner increases its output according to this command. Due to this, the air conditioner control mode becomes different from that in the normal mode, and the output current Idc is increased. As a result of this increase in the air conditioner output, the temperature in the passenger compartment will be reduced down to below the target temperature in the passenger compartment, but, during a certain interval after the auxiliary equipment output increase command has been canceled, even if the air conditioner is stopped, the room temperature will remain acceptably low due to the surplus cooling effect. Accordingly, the air conditioner may be stopped during the certain interval after the auxiliary equipment output increase command has been canceled. At this time, the air conditioner control mode returns to the normal mode.

In other words, by performing control according to this embodiment, it is possible to drive the DC-DC converter 10 at high efficiency, and moreover the beneficial effect is obtained of reduction of the overall energy consumption of the system, since the increase of energy consumption that accompanies the air conditioner output increase described above and the reduction thereof that accompanies the subsequent stopping of air conditioner operation almost cancel one another out.

(c) When “Vb_L<Vb≦Vb_H” and moreover “Idc>Tg_Idc”.

In the first embodiment, in order to bring the output current Idc close to the index current value Tg_Idc, in other words in order to bring down the output current Idc and to make the difference between the output current Idc and the index current value Tg_Idc become small, the integrated controller 7 controls the current control element 22 so as to limit the charging current to the low voltage battery 9. However, in this second embodiment, in addition to this type of control, as shown in FIG. 9C, it becomes simpler and easier to bring the output current Idc close to the index current value Tg_Idc, since it is possible also to employ reduction of the output of a portion of the auxiliary equipment 8 in parallel with the above method of control.

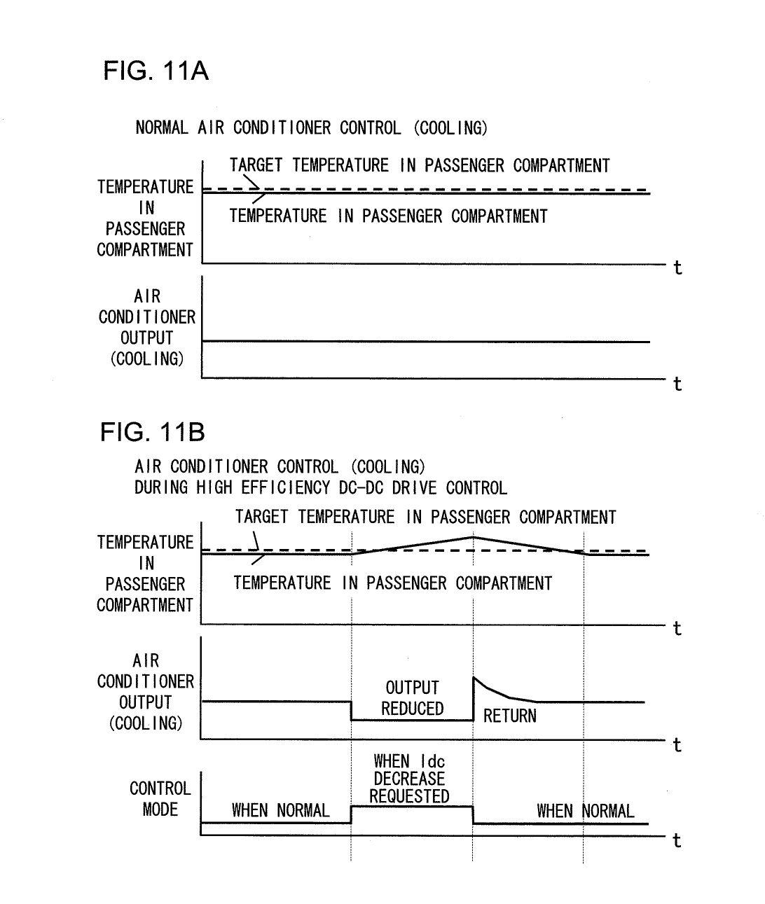

A concrete example of reduction of the output of the auxiliary equipment will now be explained with reference to FIGS. 11A and 11B, while taking an air conditioning device of an air conditioner or the like (not shown in the figures) as an example of a portion of the auxiliary equipment 8. FIG. 11B shows an example of the change over time of air conditioner control (for cooling), and, for comparison, normal control of the air conditioner is shown in FIG. 11A.

In normal control, the output of the air conditioner is always kept constant irrespective of the passage of time, but by contrast, in this embodiment, during an interval in which an auxiliary equipment output decrease command is being generated by the integrated controller 7, the air conditioner decreases its output according to this command. Due to this, the air conditioner control mode becomes different from that in the normal mode, and the output current Idc is decreased. As a result of this decrease in the air conditioner output, the temperature in the passenger compartment will be raised up to above the target temperature in the passenger compartment, but, by suppressing the amount of temperature elevation within a permissible range by regulating the amount of reduction of the air conditioner output and the period of that reduction, it is possible to drive the DC-DC converter 10 at high efficiency, and moreover it becomes possible to keep down the overall power consumed by the air conditioner. At this time, the air conditioner control mode returns to the normal mode.

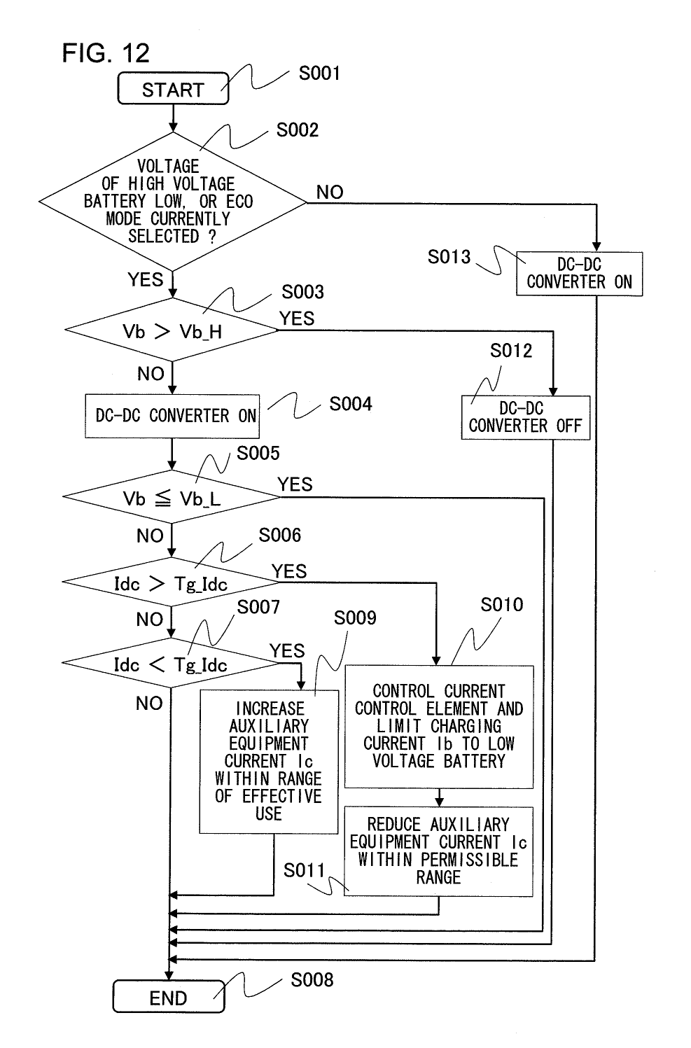

Next, a flow chart of the control procedure performed by the integrated controller 7 for performing the control described above is shown in FIG. 12. In the following, only the differences from the first embodiment will be described. While, in this second embodiment, it is necessary to take into account the logic of regulation of the output of auxiliary equipment, as represented by the air conditioner output regulation described above, it is still desirable to perform main control while limiting the occasions in which power saving operation is required, in order for there to be no loss of comfort due to such regulation of the output of the auxiliary equipment. Thus, in a step S002, the integrated controller 7 makes a decision as to whether or not either of the states “voltage of high voltage battery (amount of stored power) is low” or “eco mode is currently selected” holds at the moment. If either of these states currently holds, then the flow of control proceeds to a step S003 so that power saving operation is performed, while if neither of these states currently holds then the flow of control is transferred to a step S013 and this processing flow terminates after the integrated controller 7 has turned the DC-DC converter 10 ON.

Furthermore, after the integrated controller 7 has made a decision in a step S006 as to whether or not the condition “Idc>Tg_Idc” holds, in the case of “yes” the flow of control proceeds to a step S010, and the integrated controller 7 controls the current control element 22 and limits the charging current Ib to the low voltage battery 9 so as to cause the output current Idc to approach the index current value Tg_Idc. Next the flow of control proceeds to a step S011, in which, if a difference remains between the output current Idc and the index current value Tg_Idc even after the step S010, then the integrated controller 7 brings down the output current Idc by reducing the output of the auxiliary equipment within a permissible range, and then this processing flow terminates.

Moreover, in the case of “no” in the step S006, the flow of control proceeds to a step S007, in which the integrated controller 7 makes a decision as to whether or not the condition “Idc<Tg_Idc” holds. In the case of “no”, this processing flow terminates after the integrated controller 7 has raised the output current Idc by increasing the output of auxiliary equipment such as an air conditioner or the like within a permissible range, so as to bring the output current Idc close to the index current value Tg_Idc. Moreover this processing flow terminates in the case of “no” in the step S007, in other words if Idc=Tg_Idc.

With the control device for an electrically powered vehicle 50 of this second embodiment, similar beneficial operational effects are obtained as in the case of the first embodiment. Moreover, with the control device for an electrically powered vehicle 50 of this second embodiment, the current control element 22 also takes off the charging current Ib on the basis of the output current Idc and the supplied current Ic, in this output current Idc, that is to be supplied to the auxiliary equipment 8. The integrated controller 7 also controls the output of the auxiliary equipment 8. When the value of the output current Idc is smaller than the index current value Tg_Idc that gives the current outputted from the low voltage battery 9 side of the DC-DC converter 10 when its conversion efficiency η is at its highest value, then the integrated controller 7 raises the output current value of the output current Idc by controlling the output of the auxiliary equipment 8, and makes the difference between this output current value and the index current value Tg_Idc small. By the integrated controller 7 performing operation of auxiliary equipment and power regulation related to the power supply to the low voltage battery 9 while monitoring the output current Idc of the DC-DC converter 10, it becomes possible to operate the DC-DC converter 10 at high efficiency. This yields the beneficial operational effects that it is possible to reduce the consumption of power when operating the auxiliary equipment, and that it is possible to implement extension of the range of the electrically powered vehicle.

### Variant Embodiments

(1) While four types of current control by the integrated controller 7 for the output current Idc of the DC-DC converter 10 were shown and described above in FIGS. 6A through 6D for the first embodiment, and in FIGS. 9A through 9D for the second embodiment, in any of these embodiments, it would also be acceptable to arrange to perform any one of these four types of current control, only.

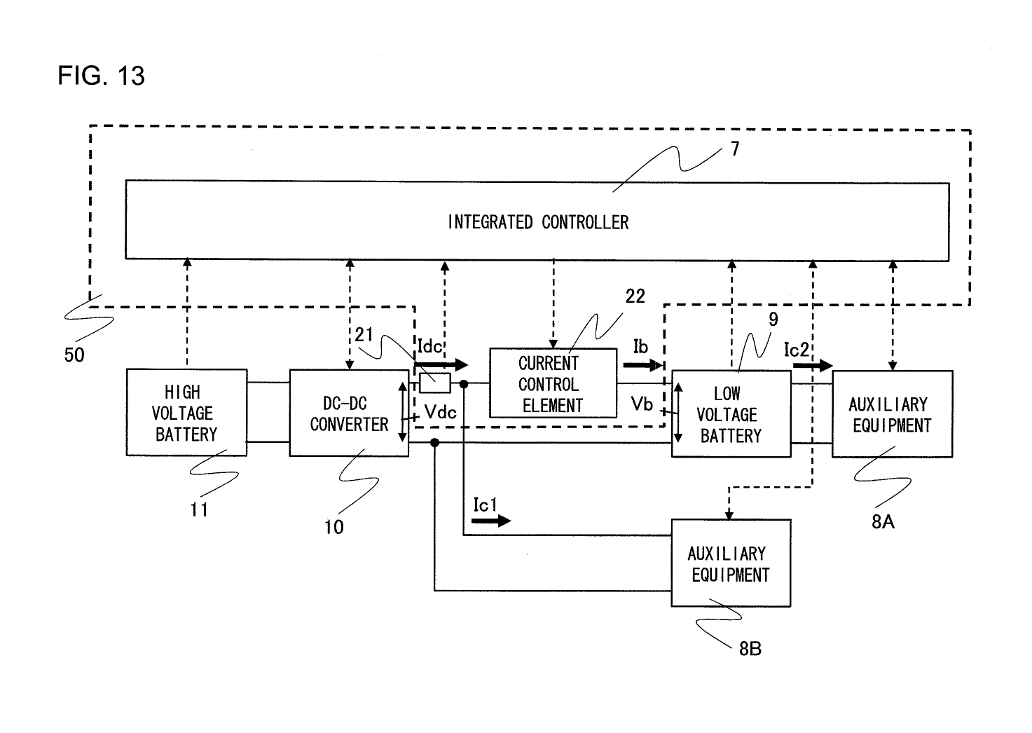

(2) A control device for an electrically powered vehicle 50 according to another variant embodiment will now be explained with reference to FIG. 13. This variant embodiment is based upon the second embodiment described above, and accordingly, in the following, only the way in which it differs from the second embodiment will be explained. In this variant embodiment, the auxiliary equipment 8 includes auxiliary equipment 8A to which it is necessary for power always to be supplied, and auxiliary equipment 8B of other types. In a similar manner to the case with the auxiliary equipment 8 in the second embodiment, this auxiliary equipment 8B is electrically connected to the low voltage battery 9 via the current control element 22, while by contrast the auxiliary equipment 8A is directly electrically connected to the low voltage battery 9, i.e. not via the current control element 22.

The auxiliary equipment 8A, for example, may include a control unit (i.e. an electronic control device), a braking system (i.e. a braking device), a power steering device (i.e. a steering assistance device), an illumination device such as a headlight (i.e. a front light) and so on, a direction indicator (a direction display device), and so on. And the auxiliary equipment 8B may, for example, include a cooling fluid pump for the motor or the inverter, a radiator fan, an air conditioning device for an air conditioner that includes a cooling fan, an infrared heater, or the like. In other words, the electrical devices that are included in the auxiliary equipment 8B are ones whose time constants are longer than the time constants of the auxiliary equipment 8A.

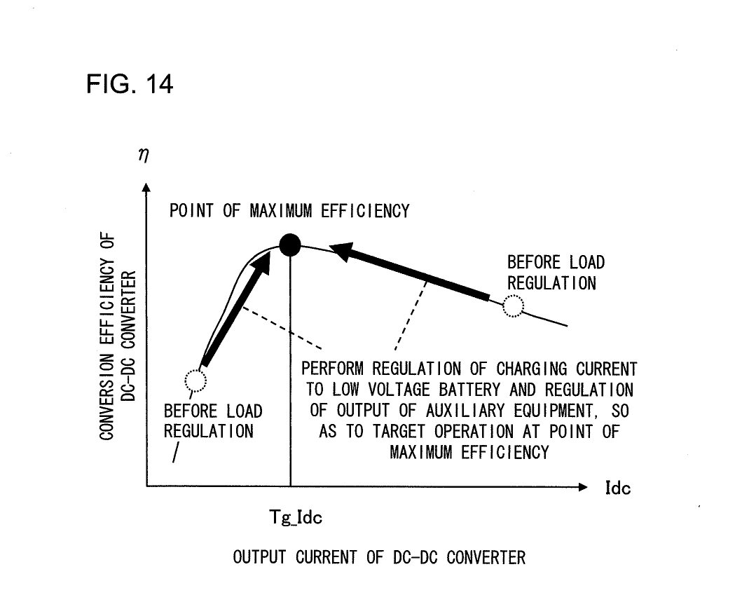

As shown in FIG. 14, along with the index current value Tg_Idc being determined in advance that specifies the output current Idc of the DC-DC converter 10 on its low voltage battery 9 side when the conversion efficiency η of the DC-DC converter 10 attains its highest value, also the output current Idc is always monitored. And, along with the integrated controller 7 increasing and decreasing the current Ic that is supplied to the auxiliary equipment 8B by regulating the output of the auxiliary equipment 8B in order to bring the output current Idc close to the index current value Tg_Idc, also the integrated controller 7 increases and decreases the charging current Ib by controlling the current control element 22, thus regulating the power supplied to the low voltage battery 9. In this manner, it is possible to increase and decrease the output current Idc that is obtained as the sum of the charging current Ib and the supplied current Ic.

In this variant embodiment, a feature that is different from case of the second embodiment is that only the auxiliary equipment 8B is directly connected to the DC-DC converter 10 and to the current control element 22, while on the other hand the auxiliary equipment 8A is directly connected to the low voltage battery 9. Due to this, even if the state of the DC-DC converter 10 being OFF due to some malfunction such as a fault in a component or the like and the condition of the current control element 22 being OFF both take place at once, nevertheless the supply of power is still ensured from the low voltage battery 9 to the auxiliary equipment 8A. Thus, according to this structure for the control device for an electrically powered vehicle 50 according to this variant embodiment, it is possible to perform high efficiency operation of the DC-DC converter with higher safety, since it is possible to change the output of the auxiliary equipment 8B, while still guaranteeing the supply of power to the auxiliary equipment 8A.

The embodiments described above are examples, and various modifications can be made without departing from the scope of the invention.

What is claimed is:

1. A control device for an electrically powered vehicle, mounted to the electrically powered vehicle, and comprising:
a current control element that takes off a charging current to be supplied to a low voltage battery that supplies power to auxiliary equipment mounted to the electrically powered vehicle in order to charge up the low voltage battery from an output current on the low voltage battery side of a voltage conversion device that performs voltage conversion between voltage of a high voltage battery that, along with supplying power to a motor that propels the electrically powered vehicle and power to the auxiliary equipment, charges up the low voltage battery and voltage of the low voltage battery; and
an integrated control unit that determines a charging current value for the charging current based upon accumulated power information related to power accumulated in the low voltage battery and conversion efficiency of the voltage conversion by the voltage conversion device, and that controls the current control element so as to take off the charging current specified by the charging current value with the current control element.

2. A control device for an electrically powered vehicle according to claim 1, wherein,
when an output current value of the output current is larger than a index current value that specifies current outputted from the low voltage battery side of the voltage conversion device when the conversion efficiency is at a highest value, the integrated control unit pulls down the output current value by controlling the current control element, so as to make difference between the output current value and the index current value small.

3. A control device for an electrically powered vehicle according to claim 2, wherein,
when the output current value is higher than the index current value, and the voltage of the low voltage battery is lower than a first threshold value, the integrated control unit stops control of the current control element for lowering the output current value.

4. A control device for an electrically powered vehicle according to claim 1, wherein:
the current control element further takes off the charging current based upon the output current and supplied current supplied, from the output current, to the auxiliary equipment; and
the integrated control unit further controls output of the auxiliary equipment and, when an output current value of the output current is smaller than an index current value that specifies current outputted from the low voltage side of the voltage conversion device when the conversion efficiency is at a highest value, the integrated control unit pulls up the output current value by controlling the output of the auxiliary equipment, so as to make difference between the output current value and the index current value small.

5. A control device for an electrically powered vehicle according to claim 4, wherein:
the auxiliary equipment includes first auxiliary equipment and second auxiliary equipment whose time constant is longer than time constant of the first auxiliary equipment;
the first auxiliary equipment is electrically connected to the low voltage battery, not via the current control element;
the second auxiliary equipment, along with being electrically connected to the low voltage battery via the current control element, is also electrically connected to the high voltage battery via the voltage conversion device; and
when the output current value is smaller than the index current value, the integrated control unit pulls up the output current value by controlling output of the second auxiliary equipment, so as to make the difference small.

6. A control device for an electrically powered vehicle according to claim 5, wherein
the first auxiliary equipment includes at least one of an electronic control device, a braking device, a power steering device, an illumination device, and a direction display device.

7. A control device for an electrically powered vehicle according to claim 1, wherein:
the integrated control unit further controls the voltage conversion device, and, when the voltage of the low voltage battery is greater than a second threshold value, the integrated control unit makes the output current value approximately zero by controlling the voltage conversion device; and
the auxiliary equipment is supplied with power by the low voltage battery.

8. A control device for an electrically powered vehicle according to claim 1, wherein
the current control element includes any electric circuit element of an electric circuit element that either takes off or does not take off the charging current according to control by the integrated control unit and an electric circuit element that is capable of continuously changing the charging current value of the charging current that is taken off according to the control by the integrated control unit.

9. A control device for an electrically powered vehicle according to claim 1, further comprising
a current value detection device that measures output current value of the output current, wherein
either: the current value detection device is disposed between the voltage conversion device and the current control element that are mutually electrically connected together, and between the voltage conversion device and the auxiliary equipment that are mutually electrically connected together, and is electrically connected to the voltage conversion device, to the current control element, and to the auxiliary equipment; or the current value detection device is included in the voltage conversion device, and is electrically connected to the current control element and to the auxiliary equipment.
